(19) United States
(12) Patent Application Publication
(10) Pub. No.: US 2016/0324265 A1
(43) Pub. Date: Nov. 10, 2016

(54) ERGONOMIC SHOE AND BOOT GRIP APPARATUS

(71) Applicant: Brandon GELLER, Toronto (CA)

(72) Inventor: Brandon GELLER, Toronto (CA)

(21) Appl. No.: 15/148,613

(22) Filed: May 6, 2016

Related U.S. Application Data
(60) Provisional application No. 62/158,885, filed on May 8, 2015.

(51) Int. Cl. A43B 13/36; A43B 1/00; B29D 35/12; A43B 13/22; A43C 15/06; A45B 9/00; A43B 13/14

(52) U.S. Cl. CPC A43B 13/36; A45B 9/00; A43B 1/0054; A43B 13/141; A43B 13/223; A43C 15/061; B29D 35/122

(57) ABSTRACT

An apparatus is provided that allows a person with disability issues—such flexibility and mobility problems, arthritis, muscle weakness, and the like—to attach and detach a spiked sole (or other grip enhancing sole) from a regular shoe or boot. A midsole is provided that can be attached to the shoe or boot, is suitable for use as the sole of the boot, and can be left on for the winter season. A bottom spiked sole is provided that can be attached to the midsole by simply stepping on the bottom sole. The bottom sole may be detached by engaging a release button on the heel of the midsole. The overall system includes a cane or attachment to a cane that allows the user to pick up the bottom sole when not in use.

### FIELD OF THE INVENTION

This invention provides an apparatus which allows people with flexibility and mobility problems, arthritis, muscle weakness, and the like—often the elderly—to more easily attach and detach a bottom sole to a shoe or boot without bending over, said bottom sole providing a better gripping surface such as spikes when walking outdoors on ice or snow. A cane or attachment to a cane allows the user to pick up the bottom sole when not in use without bending over.

### BACKGROUND

Certain people, particularly those who are elderly, have difficulties with flexibility and mobility problems, arthritis, muscle weakness, “the shakes”, or poor eyesight. Flexibility issues make it difficult for many of the elderly to bend over without losing balance, or in some cases to bend over at all. Such issues create a greater likelihood of slipping and falling when walking outdoors on ice and/or snow.

One known approach is for people concerned with slipping and falling on ice and snow to purchase shoes or boots with a spiked sole. This can be effective at reducing the likelihood of falling; however, if the person then enters a building or other location where spikes on the bottom of the shoes or boots are undesirable (such as a supermarket), dangerous to use (i.e. the spikes or gripping apparatus may create their own slipping problems on a hard, smooth floor), or simply not allowed, the person has to remove the shoes or boots with the spiked soles and put on a second pair of boots or shoes. This is undesirable, as this requires the person to carry a second set of footwear, and often there is no convenient place provided for an elderly person to sit down and change footwear. A person with flexibility and/or mobility problems, arthritis, muscle weakness, “the shakes”, or poor eyesight may have difficulty making such a change in footwear.

It is known in the prior art to have shoes or boots whose soles are adapted to allow spikes or other grip-enhancing features to be attached and detached. It is also known to have shoes or boots with spikes that retract into the sole. See, for example, U.S. Pat. No. 5,269,080 of Davis. It is also known to have shoes or boots whose soles are adapted to allow a second sole (with spikes or other grip-enhancing features) to be attached and detached from the sole of the shoe or boot. See, for example, U.S. Pat. No. 4,267,650 of Bauer, U.S. Pat. No. 5,644,857 of Oulette et al., U.S. Pat. No. 5,661,915 of Smith, U.S. Pat. No. 6,032,386 of Evans. However, these solutions require the purchase of a specialized shoe or boot, typically an expensive proposition. This is even more expensive if the person requires a customized shoe or boot for some medical reason. Also, it is known to attach a sole to a shoe or boot, and then be able to attach or detach spikes from the sole, as in U.S. Pat. No. 7,409,782 of Larson. One difficulty with these approaches is that they often necessitate a thick sole or combination of soles, much thicker than on a normal winter boot or shoe, which can be unstable in use and add to the difficulties of persons struggling with balance and slipping issues.

Generally, all of these solutions still present difficulties for the user who has flexibility and mobility problems, arthritis, muscle weakness, “the shakes”, or poor eyesight. A person with flexibility issues would not want to (and may not be able to) bend over or sit down to attach or detach the spikes and/or a sole. A person with arthritis, muscle weakness, the shakes or poor eyesight may struggle to detach and attach spikes and/or a sole, or operate mechanisms to retract and extend spikes.

### SUMMARY

There is a need for an improved system to provide spikes or some other grip-enhancing features on the bottom of regular shoes and boots. These should be easy to attach and detach and minimize the need for the wearer to bend over or sit down when attaching and detaching the spikes or grip-enhancing features. They attach and detach in such a way as to make it easier for a person with arthritis, muscle weakness, the shakes or poor eyesight to do the attachment and detachment. When detached, the shoe or boot should be capable of being worn indoors in, for example, a supermarket. The system should attempt to minimize the thickness of the combined soles when the device is worn. When not in use, the spikes or grip-enhancing features should be easy to pick off the ground, portable and easily carried around, and preferably should fit easily into a pocket.

The present invention provides a mid-sole which is a sole that can be detachably attached to the sole of a regular boot or shoe. The midsole is designed for easy but robust attachment. Once attached, the midsole provides a suitable sole for everyday use, and can be used indoors on hard surfaces. The midsole can be left on the regular shoe or boot for the entire winter season.

The midsole also provides receiver ports by which a bottom sole may be detachably attached to the midsole. The attachment is such that it may more easily be made by a person with flexibility/mobility issues, arthritis, muscle weakness, the shakes or poor eyesight without the need to bend over or sit down. The attachment is also such that the bottom sole may be easily detached without bending or sitting down by pressing a release button on the heel of the midsole, typically by gently knocking the heel of the regular boot or shoe against any convenient surface. The midsole is designed to minimize its thickness to minimize its effect upon the user's mobility.

The bottom sole provides connectors that mate with the receiver ports on the midsole portion. The lower surface of the bottom sole is provided with spikes or some other gripping mechanism. The bottom sole itself is manufactured from a thin, flexible but robust material, and when not in use the bottom sole may be folded and carried in the pocket.

The connectors and receiver ports may mate in a number of ways. In one option, the connectors and receiver ports detachably attach through the use of magnets. In another option, the connectors and receiver ports detachably attach through a pin system.

There is also optionally provided a cane attachment, designed to attach to the bottom of a cane (where the cane touches the ground). A magnet is provided in the cane attachment. If the connectors in the bottom sole are equipped with complementary magnets, the bottom sole may be picked up off the ground without bending or sitting by using the magnet in the cane attachment on the cane to pick up the bottom sole. Alternatively, a magnet may be simply built into a cane (or other reaching device) to provide the same functionality.

The midsole and bottom sole together form an apparatus for the easier attachment and removal of the grip-enhancing bottom sole from regular shoes and boots. When the cane or cane attachment is added, the result is a system where the grip enhancing bottom sole may be taken out of a pocket, attached to the regular shoes or boots, used, then detached, picked off the ground, and placed back in the pocket, all without the user bending over or sitting down.

In accordance with the present invention, there is provided a midsole and a bottom sole; said midsole having a main component, at least one front body, a piece of material connecting the main component and at least one front body, and means for attaching the midsole to an ordinary boot or shoe, the main component having a bottom surface and at least two receiver ports on the bottom surface, and a release mechanism with a release button; said bottom sole having an upper surface and a lower surface, a grip enhancement device on its bottom surface and at least two connectors on its upper surface; where said at least two connectors are adapted to attach by mating with the at least two receiver ports, and once attached the at least two connectors may be detached from the at least two receiver ports by engaging the release button.

In another aspect of this invention, the release mechanism is a slider with pins that intrude into the receiver ports and is biased by a spring. In another aspect of this invention, the piece of material is elastic. In another aspect of this invention, the piece of material is between 3-5 mm in thickness with a tensile strength of 2-3 MPa. In another aspect of this invention, the main component is between ⅜″ to ½″ thick and made with a material with a Shore A number of around 40. In another aspect of this invention, there is also provided a cane with a first magnet and a second magnet in the at least two connectors, the first and second magnets being oriented to attract. In another aspect of this invention, there is also provided a cane attachment with a first magnet and a second magnet in at least one of the at least two connectors, the first and second magnets being oriented to attract. In another aspect of this invention, there is provided an elastic port cover covering at least one receiver port. In another aspect of this invention, the at least two connectors are adapted to attach by mating with the at least two receiver ports using port magnets and connector magnets, and once attached the at least two connectors may be detached from the at least two receiver ports by engaging the release button. In another aspect of the invention, the at least two connectors include a first magnet and the release mechanism includes a second magnet, where the first and second magnets are aligned to allow for detachable attachment of the midsole and bottom sole. In another aspect of this invention, the release mechanism includes a spring and the second magnets intrudes into a receiver port when biased by the spring. In another aspect of the present invention, the second magnet slides out of the receiver port when the release button is engaged.

In accord with the present invention, there is provided a kit comprising a midsole having a main component, at least one front body, a piece of material connecting the main component and at least one front body, and means for attaching the midsole to an ordinary boot or shoe, where the main component has a bottom surface and at least two receiver ports on the bottom surface, and a release mechanism with a release button; a bottom sole having an upper surface and a lower surface, a grip enhancement device on its bottom surface and at least two connectors on its upper surface where at least one connector has a first magnet, where said at least two connectors are adapted to attach by mating with the at least two receiver ports, and once attached the at least two connectors may be detached from the at least two receiver ports by engaging the release button, and a cane attachment with a second magnet, the first and second magnets being oriented to attract. In one aspect of this invention, the release mechanism is a slider with pins that intrude into the receiver ports and is biased by a spring. In another aspect of this invention, the release mechanism includes a third magnet, where the first and third magnets are aligned to allow for detachable attachment of the midsole and bottom sole. In another aspect of this invention, the release mechanism includes a spring and the third magnet intrudes into a receiver port when biased by the spring and the third magnet slides out of the receiver port when the release button is engaged.

In accord with the present invention, there is provided a method of use of the invention, comprising the steps of: attaching a midsole to a regular shoe or boot; wearing the shoe or boot; placing the bottom sole on the ground with the connectors facing upwards; attaching the bottom sole to the midsole by stepping on the bottom sole with the midsole. In another aspect of this invention, there is provided the further step of releasing the bottom sole from the top sole by engaging the release button.

In accord with the present invention, there is provided a method of use of the invention, comprising the steps of: attaching a midsole to a regular shoe or boot; wearing the shoe or boot; placing the bottom sole on the ground with the connectors facing upwards; attaching the bottom sole to the midsole by stepping on the bottom sole with the midsole; releasing the bottom sole from the top sole by engaging the release button; using the attraction between the second magnet and the first magnet to pick the bottom sole off the ground.

### BRIEF DESCRIPTION OF THE DRAWINGS

The embodiments of the present invention shall be more clearly understood with reference to the following detailed description of the embodiments of the invention taken in conjunction with the accompanying drawings, in which:

FIG. 1 is a side view of a midsole, bottom sole and shoe or boot;

FIG. 2 is an illustration of the construction of the midsole from the underside;

FIG. 3 is an illustration of the midsole from the side, illustrating its method of attachment to a regular shoe or boot;

FIG. 4 is an illustration of the midsole from the side, illustrating its method of attachment to a regular shoe or boot;

FIG. 5 illustrates the bottom sole from its underside;

FIG. 6 is an exploded view of the bottom sole;

FIG. 7 illustrates the bottom sole from the topside;

FIG. 8 is a top down view of the midsole;

FIG. 9 illustrates the method of attaching the bottom sole to the midsole in use;

FIG. 10 illustrates the method of detaching the bottom sole from the midsole in use;

FIG. 11 is a side view of the cane attachment;

FIG. 12 is a top view of the cane attachment;

FIG. 13 illustrates the use of the cane attachment to pick up a bottom sole;

FIG. 14 illustrates an elastic port cover, and apparatus to use magnets to attach the bottom sole to the midsole;

FIG. 15 illustrates the use of an elastic port cover, and illustrates the use of magnets to attach the bottom sole to the midsole;

FIG. 16 illustrates the use of an elastic port cover, and magnets to attach the bottom sole to the midsole, in the attached position;

FIG. 17 illustrates the method of detaching the bottom sole from the midsole when using magnets to attach the bottom sole to the midsole;

FIG. 18 illustrates the mechanism for attaching the bottom sole to the midsole using magnets, in position for attaching the bottom sole; and

FIG. 19 illustrates the movement and positioning of the mechanism for attaching the bottom sole to the midsole using magnets when detaching the bottom sole.

### DETAILED DESCRIPTION

The description which follows and the embodiments described therein are provided by way of illustration of an example, or examples of particular embodiments of the principles and aspects of the present invention. These examples are provided for the purposes of explanation and not of limitation, of those principles of the invention. In the description that follows, like parts are marked throughout the specification and the drawings with the same respective reference numerals.

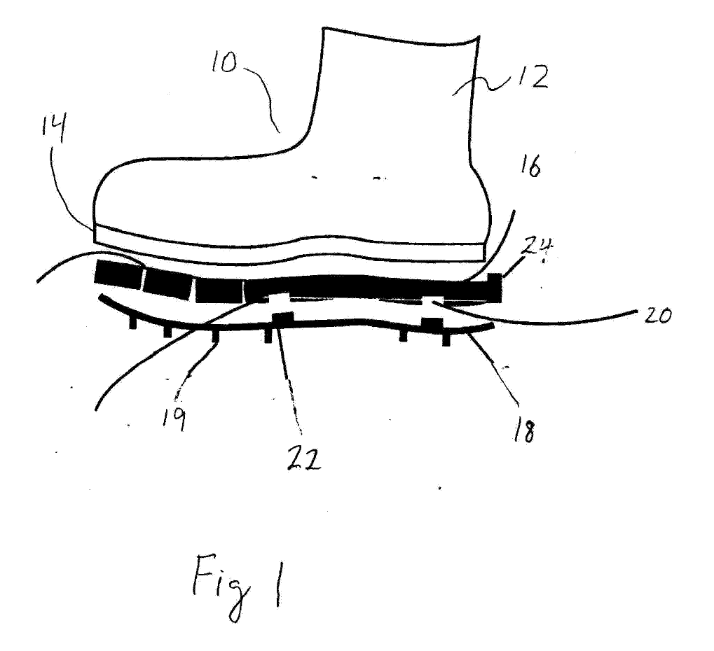

The present invention provides a system for providing detachably attachable spikes or other gripping mechanism for use with regular shoes or boots, which may be attached and detached without bending or sitting down, and may be more easily used by those with flexibility, mobility, arthritis, muscle weakness, the shakes, or eyesight issues. Turning to FIG. 1, there is illustrated an ordinary boot or shoe 10, which is not part of the invention. The boot or shoe 10 has an upper part 12 and a sole 14. The inventive apparatus includes a midsole 16 and a bottom sole 18. The midsole 16 has receiver ports 20 which mate with connectors 22 in the bottom sole 18. Bottom sole 18 is provided with spikes 19. As will be explained in more detail below, the connection between the receiver ports 20 and connectors 22 is such that it is easy to attach bottom sole 18 to midsole 16 by the user stepping on the bottom sole 18 while wearing the boot or shoe 10 with the midsole 16 attached. The bottom sole 18 may be detached by pressing release button 24.

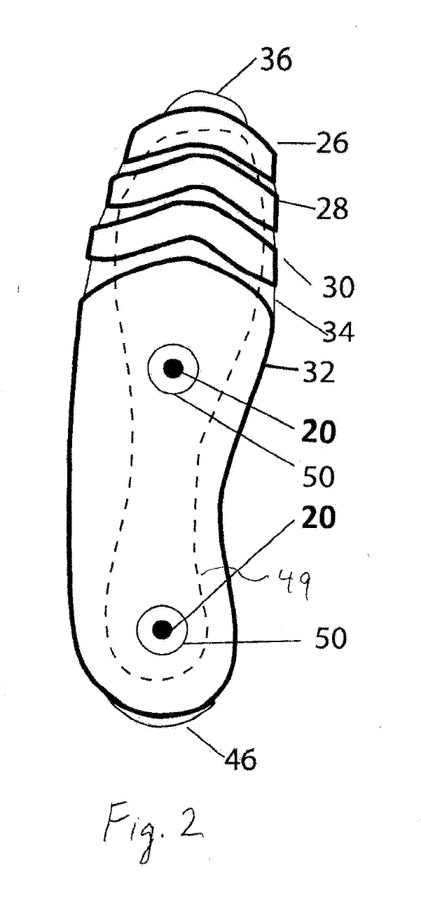

FIG. 2 shows the construction of the midsole from the underside. Turning to FIG. 2, the midsole consists of three front bodies 26, 28, and 30 and a main component 32. The three front bodies 26, 28, and 30 are shaped or bent in such a way that no matter where they are stretched, the bottom sole 18 will always be touching one of the front bodies 26, 28, and 30 at the tip (if the front bodies 26, 28, and 30 were cut straight across, the tip of the bottom sole could end up in one of the gaps between the bodies 26, 28, and 30 and get stuck or simply have no support when in contact with the ground). Note that the number of front bodies can be varied and still fall within the scope of the invention. The three bodies 26, 28 and 30 are attached to the front of main component 32 (front being in the direction of the toes when worn) by a thin, elastic material 34. The elastic material 34 has a low durometer, which allows the elastic material to stretch with a “reasonable” force, allowing an individual that lacks strength to install the midsole but with enough elastic strength to retain tension. This allows the midsole 16 to conform to the user's boot or shoe size and retain tension underneath the shoe or boot, ensuring a secure connection along the length of the midsole 16. Front body 26 has a toe cap 36, which slips over the front of the shoe or boot. The ability to stretch allows the midsole to lengthen and adapt to a variety of shoe/boot sizes and styles within the Small, Medium, Large designation. For example within the range of small (sizes 6-8) the device will always stay secure on the users shoe/boot and in tension whether the boot is size 6 or size 8. There is no compromise as is the case with some other current traction aid devices that may offer a size 7 for “small” and assume users with size 6 and 8 will be able to use it as well.

Covering the spectrum of sizes within Small, Medium, Large as the midsole 16's design allows also has advantages in manufacturing, as this design requires only 3 molds as opposed to a non-stretching device that would require many different sizes or a compromised, non-ideal fit for the user. Providing a stretch to fit design for midsole 16, reduces mold costs and increases user satisfaction. In addition the natural walking motion is kept intact as the material stretches and contracts with each step.

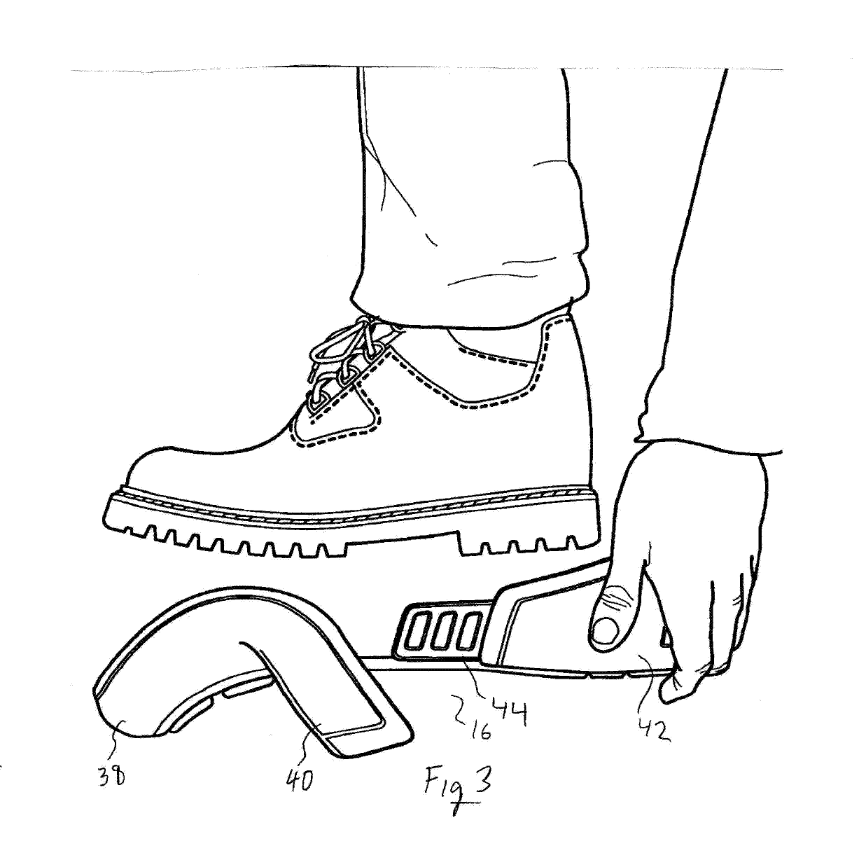

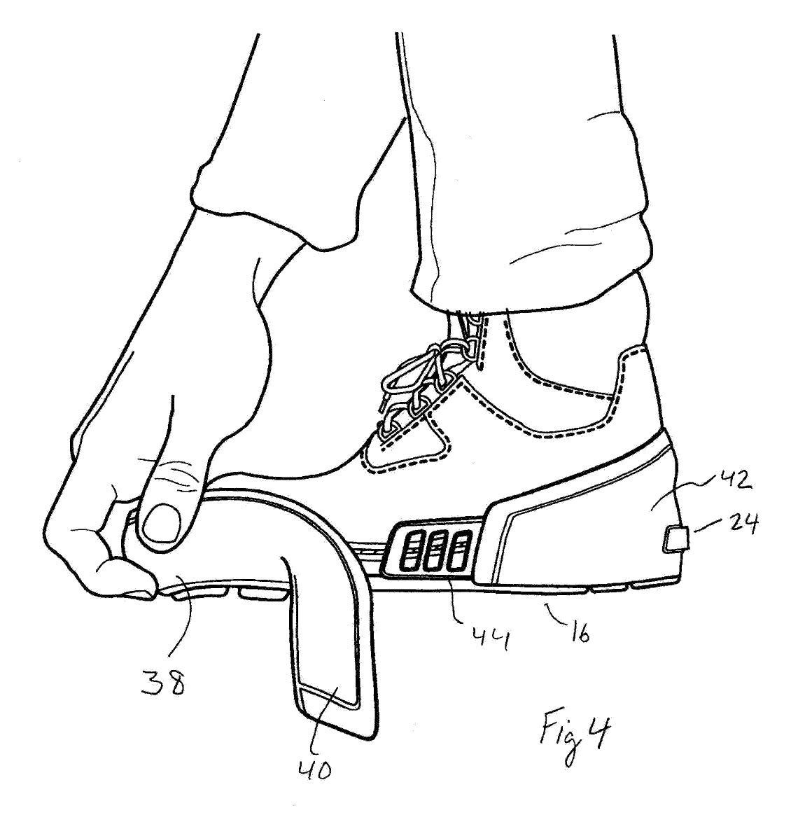

Turning to FIG. 3, the midsole 16 has a toe covering 38 attached to front member 36 that includes straps 40. Straps 40 are elastic in nature. Midsole 16 also has connected a heel cap 42 and fastening ports 44. Referring to FIGS. 3 and 4, the midsole is attached to the user's boot or shoe by first placing the heel of the shoe or boot into the heel cap 42. The toe cap 36 and toe covering 38 are pulled up over the toe of the shoe or boot. The straps 40 are provided with a hook mechanism. The hooks are positioned on the strap 40 so that when the hooks are attached to the fastening port 44 closest to the front of the midsole 16, this provides sufficient tension to keep the midsole securely on the boot or shoe. Attaching the hook to the fastening port 44 closest to the front of the midsole 16 provides the least tension while attaching the hook to the fastening port 44 farthest from the front provides the most tension. The straps 40 provide further support in the lateral directions.

Returning to FIG. 2, the heel 46 of main component 32 is made of a thicker, more ridged material to support the anchor function of the midsole 16 and heel cap 42 and promote durability.

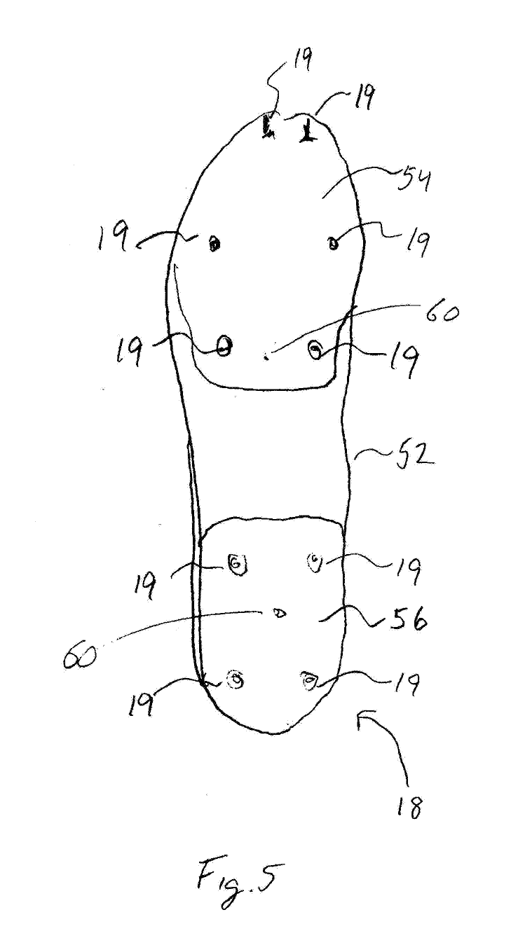

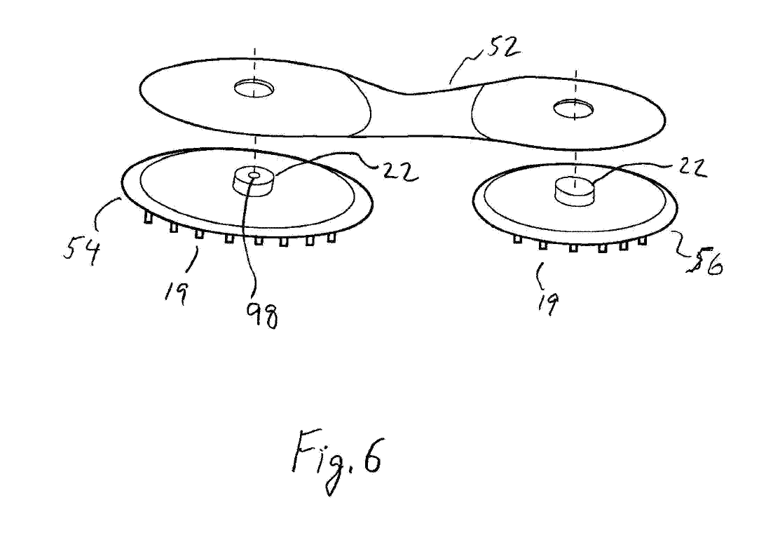

FIG. 5 illustrates the bottom sole from its underside, while FIG. 6 provides an exploded view of the bottom sole. Turning to FIGS. 5 and 6, the bottom sole 18 is made of a piece of material 52. Piece 52 is a thin rubber-like material that can stretch as to not impede the normal walking motion and can flex in the middle, between the plates, during storage. Plates 54 and 56 are comprised of a durable plastic that can flex repeatedly, is UV resistant, and durable to scratches and impact. Spikes 19 (which can be made of metal) can be either molded right into the plate or can be added on afterwards using a threaded insert fastening method, which would allow old spikes 19 to be swapped out. These plates are attached to piece 52. Different types of spikes or other gripping apparatus may be used depending on requirements. For example, spikes designed specifically for snow would be broader and less sharp than spikes designed for ice. Also, the spikes may be manufactured from many different materials.

The piece of material 52 is flexible enough so that bottom sole 18 may be folded and placed in a pocket. A waterproof pouch may be provided to store wet or dirty bottom soles 18 between uses.

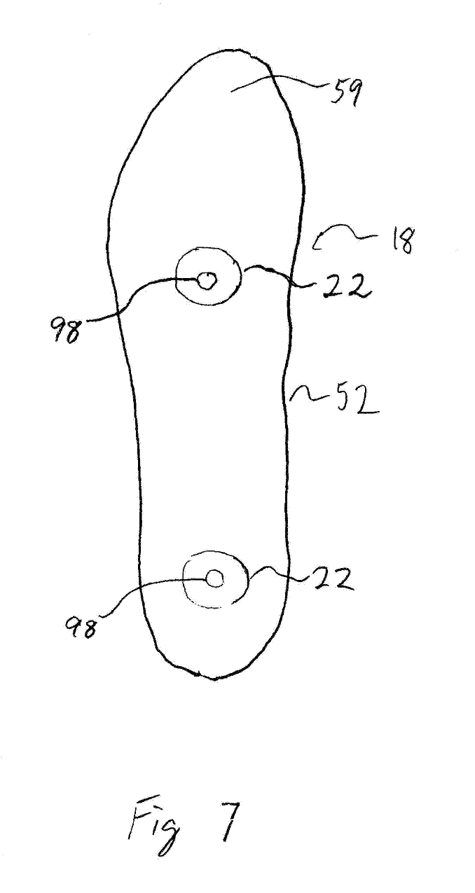

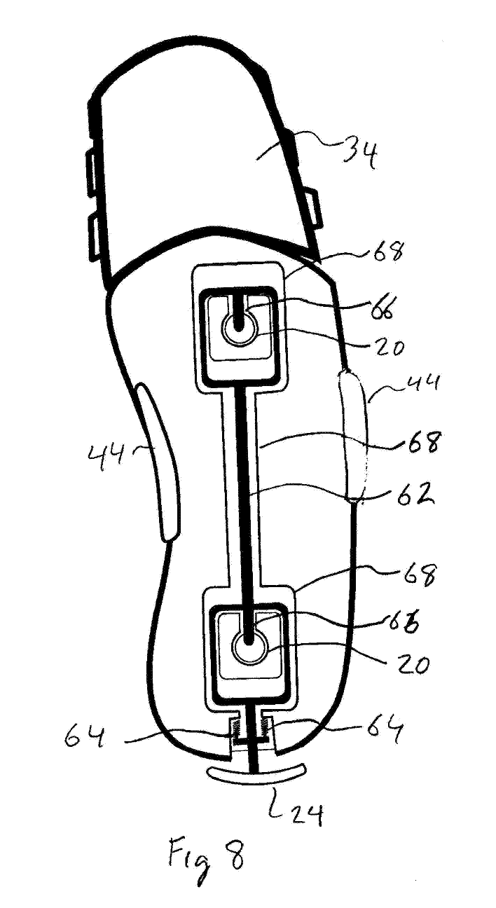

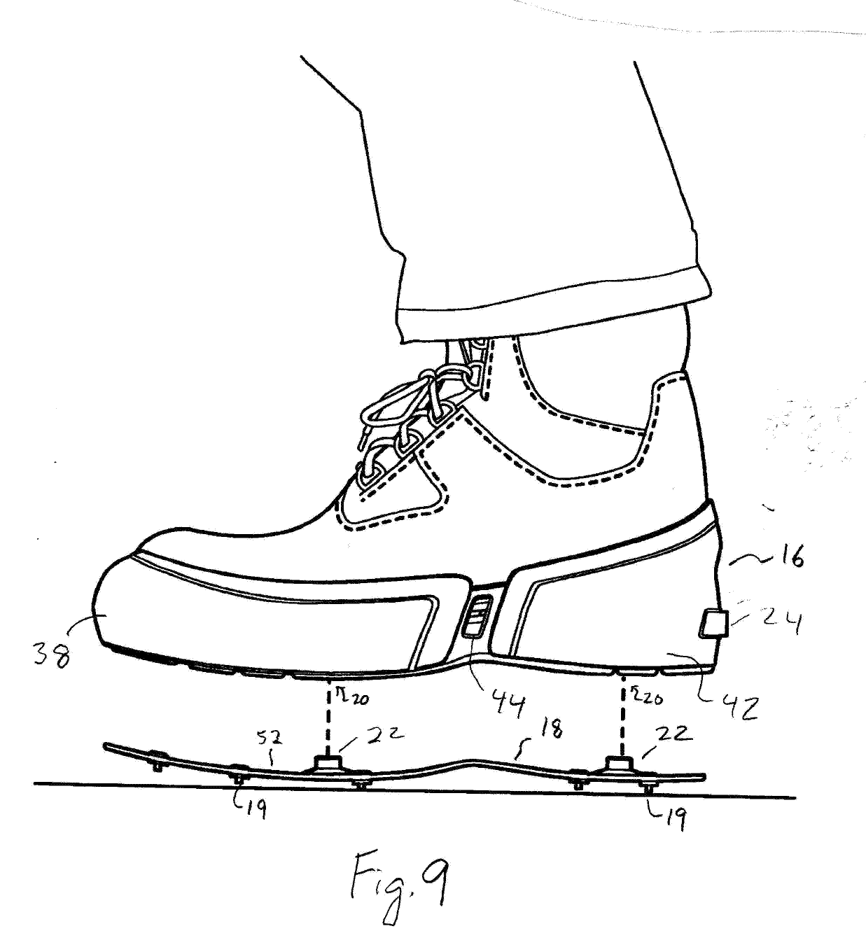

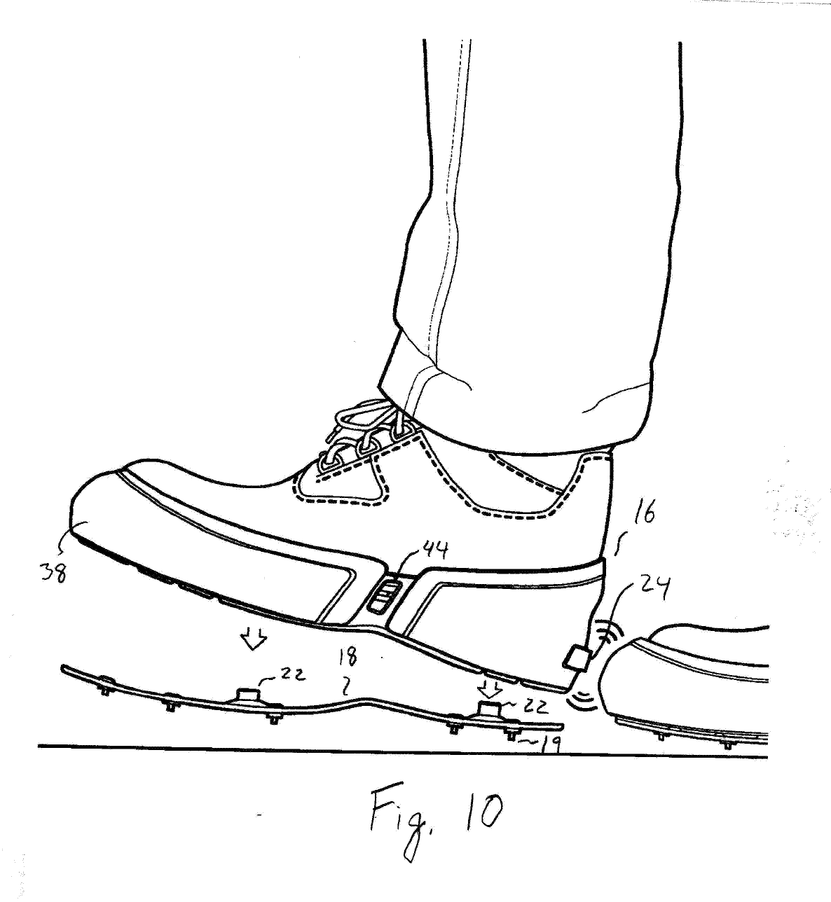

Turning to FIG. 6, connectors 22 are molded into the plates 54 and 56, and pass through openings in piece 52. FIG. 7 illustrates the bottom sole from the topside. Turning to FIG. 7, connectors 22 are exposed on the top side of bottom sole 18. The front of the bottom sole has a curved front section 59 that curves upwards (i.e. up towards the toes when in use). When the bottom sole is attached to the midsole, this prevents items such as rocks, snow or dirt from getting lodged or caught between the bottom sole and the midsole.

Returning to FIG. 2, main component 32 of midsole 16 has two receiver ports 20. The receiver ports 20 are surrounded by chamfered depressions 50 that aid in alignment with the connectors 22 of bottom sole 18. The main component 32 and front bodies 26, 28 and 30 has a depression 49 that follows the size and shape of the material 52 of bottom sole 18, allowing the perimeter of the bottom sole to nest and avoid possible disruption to the connection between the bottom sole and the midsole. The thickness of main component 32 is constrained by the undesirability of adding additional height to a boot (or shoe) that might already have a thick sole, but this must be balanced against the necessity of implementing the release mechanism described below, including imparting the necessary stiffness to main component 32.

In one embodiment, chamfered depressions 50 are (⅛″ in deep 1⅛″ in diameter), and main component 32 is ⅜″ to ½″ thick, and depression 49 is ⅛″ deep. In one embodiment, the main component 32 is made of “medium soft” Shore A 40 Santoprene™. Santoprene™ thermoplastic vulcanizate is a fully dynamically vulcanized ethylene propylene diene monomer rubber in a thermoplastic matrix of polypropylene.

Detachable attachment of the midsole and the bottom sole is provided by a mechanism that is triggered by the release button 24. FIG. 8 is a top down view of the midsole 16. Turning to FIG. 8, there is provided a slider 62 that is biased towards the heel of the midsole 16 by springs 64. Slider 62 has pins 66 that extend slightly into the receiver ports 20. A trackway 68 is cut into the main component 32 that allows the slider to move forwards and backwards (i.e. towards the toes and towards the heel of the midsole 16). The trackway 68 is covered by a thin plastic covering to prevent dirt or foreign objects from impeding the slider 62. The thin plastic covering is removable through small fastening screws, if parts below need to be accessed.

Springs 64 may be a small compression spring, or a “live” plastic hinge that uses its flex properties to create a spring-like effect, or any other method of biasing the slider 62 known in the art. In one embodiment, the trackway 68 is ⅛″ deep, and the slider is ⅛″ thick.

The slider 62 is made from a single plastic part to aid in cost reduction and simplicity in design—reducing possible breakdowns, which may be seen in complicated mechanisms that are on the market currently. Additionally this slider 62 can be replaced or repaired by the user if it wears down, because the mechanism is so simple and not fixed into the device. In addition the mechanism layout and the use of pins with a small spring also allows the release button 24 to remain close to the heel and not protrude far out—preferably between ¼″ and ⅜″, making it less likely for something to accidently hit release button 24.

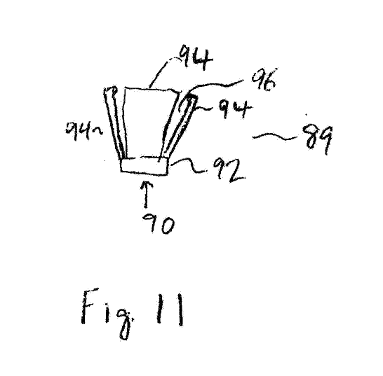

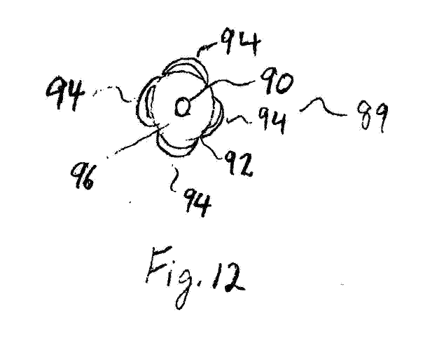

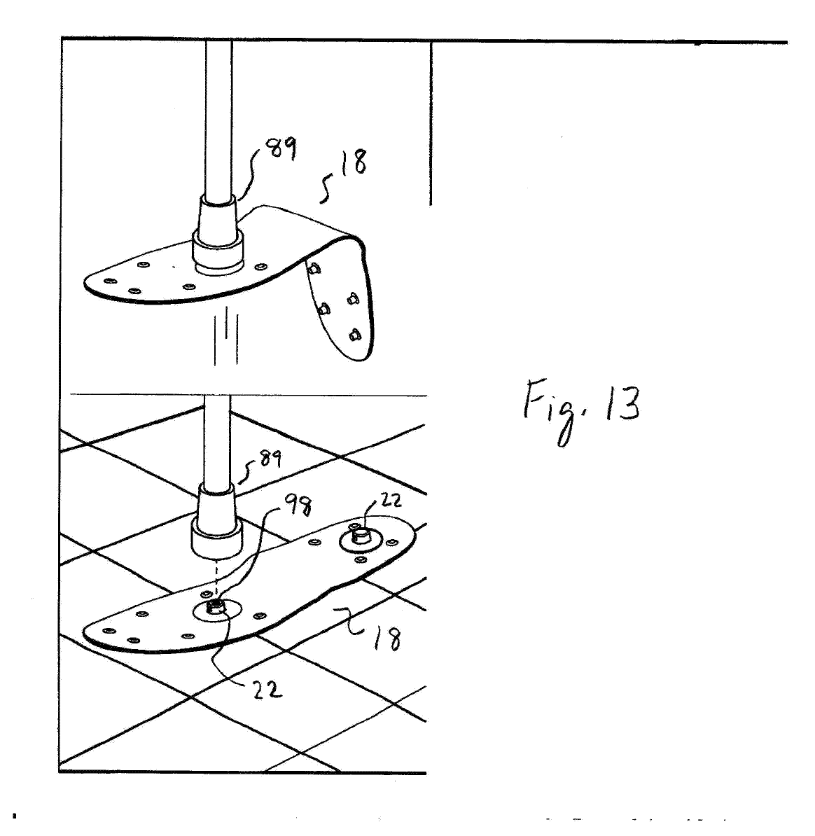

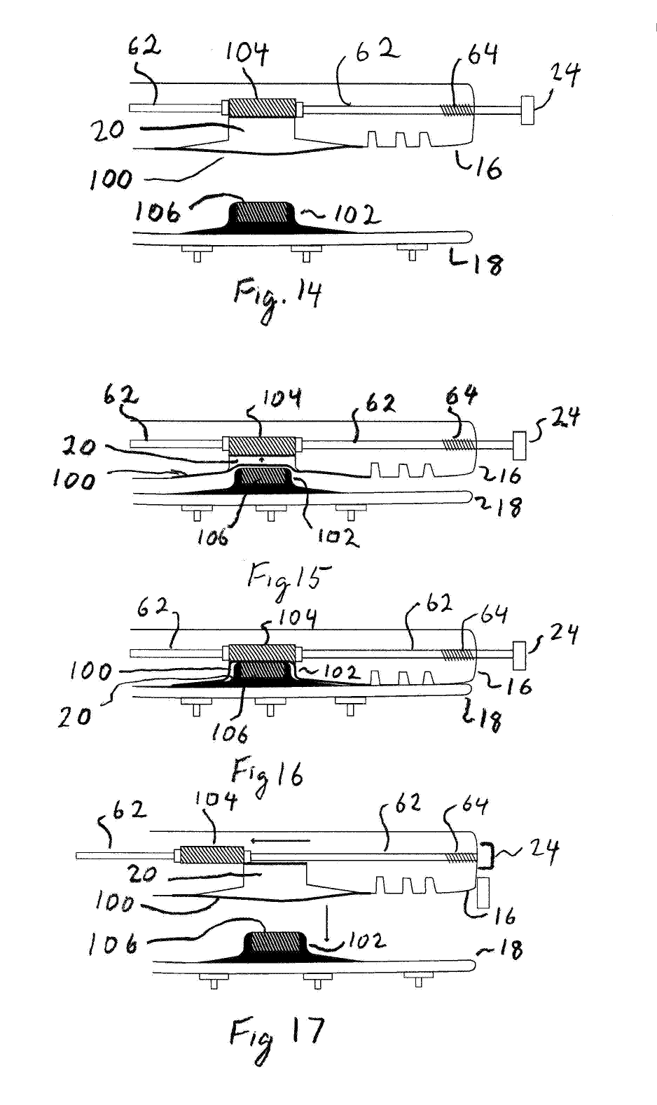

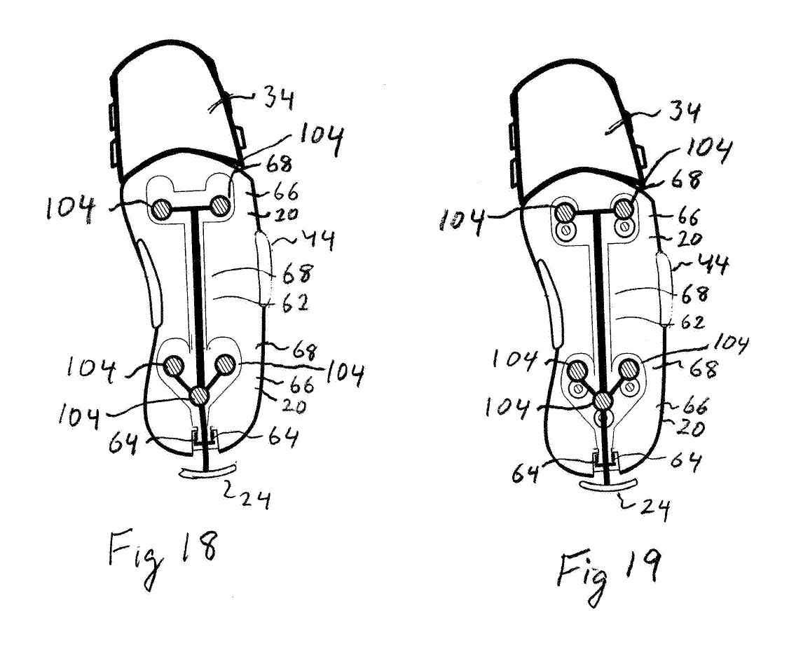

In use, the bottom sole 18 is placed on the ground with connectors 22 facing upwards. As seen in FIG. 9, the user simply steps onto the bottom sole 18 with midsole 16 (midsole 16 having been previously attached to the user's shoe or boot). The connectors 22, guided by the chamfer, inserts into receiver ports 20. The weight of the step compresses the material 52 of the bottom sole 18, allowing the connectors 22 to penetrate farther into the receiver ports 20. Once inserted, the connectors 22 are held in the receiver ports 20 by pins 66 of slider 62. The connectors 22 and receiver ports 20 are designed to interact within a tight tolerance to minimize the amount of movement when the connector 22 and receiver port 20 are locked and under pressure in natural walking motions.

To detach the bottom sole 18, the release button 24 is engaged, for example by pressing the heel of the midsole 16 against the midsole on the other foot as may be seen in FIG. 10. Engaging release button 24 moves the slider 62 towards the front (towards the toes) of the midsole, releasing the connectors 22 and allowing the bottom sole 18 to drop out of the receiver ports 20. The bottom sole 18 may then be picked up and stored for future use. When the release button 24 is disengaged, the spring 64 biases slider 62 towards the heel of the midsole, and the midsole 18 is again ready to attach to the connectors 22 of bottom sole 18.

The release mechanism, and the midsole 16 and bottom sole 18 in general, has been designed to minimize the thickness of the apparatus as much as possible so as to minimize difficulties for users with mobility or flexibility issues. The apparatus has also been designed to be simple in construction with relatively few parts, reducing the expense of manufacture of the apparatus and making the release mechanism easier to maintain and replace.

In one embodiment, elastic material 34 is manufactured from a low durometer grade of Santoprene™ (i.e. with a Shore Hardness A of around 30) between 3-5 mm in thickness. Piece of material 52 is made of Santoprene™ with a Shore Hardness A of around 35 and a tensile strength of around 2-3 MPa of 2-4 mm thickness in the middle section and 1-2 mm in thickness where it is overmolded over the bottom plates 54 and 56. Plates 54 and 56 may be made of Santoprene™ Shore A 60 through Shore A 90, or of nylon, and plates 54 and 56 are 5 mm thick at the thickest portions, reducing to 3 mm in thickness in the thinnest portions. The spikes 19 are made of tungsten carbide. The front bodies 26, 28 and 30 and main component 32 of the midsole 16 are made of “Medium soft” Santoprene™ with a Shore Hardness A of around 40. The chamfers around the receiver ports could be made from Shore D 60 Santoprene™.

One method of manufacturing the midsole 16 is via an automatic rotary injection moulding machine that uses a four piece mould to produce detail on all sides while ensuring an easy ejection process. This is a basic manufacturing process known in the art that is currently used in the production of inexpensive rubber boots and two colour sandals, slippers and shoes. This method would require the threefront midsole bodies 26, 28 and 30 to be connected afterwards by overmolding material 32 with a low durometre grade of Santoprene™. This ensures the greatest adherence of materials and allows stretch between the bodies.

If the mechanism track is specifically designed open faced (i.e. directly accessible to someone installing the slider 62), this eliminates undercuts and the need for costly removable cores. As a result the product can be produced at high volumes, low cost and high versatility in terms of design and functionality.

A second manufacturing process that could be utilized is multi-component molding, which allows the injection molding of multiple materials in one part. The bottom sole 18 may be manufactured using multi component molding to add the soft and flexible material 52, and molding the tungsten carbon spikes 19 directly into the plates 54 and 56.

Midsole 16 and bottom sole 18 form an apparatus for the attachment and detachment of bottom sole 18 to regular shoes and boots without the need for bending or sitting down, and that may be more easily used by persons with arthritis, muscle weakness, or eyesight problems.

To complete the system, there may also be provided a cane attachment accessory 89, which provides the capability of retrieving the bottom sole 18 from the ground without having to bend over or sit down and pick it up. Turning to FIGS. 11 and 12, the cane attachment 89 has a magnet 90 embedded inside a plastic or rubber-like housing 92. Generally, the cane attachment can utilize any known method of attaching the magnet to a cane (or other reaching device). In the embodiment illustrated in FIGS. 11 and 12, extending upwards from housing 92 are four rubber claws 94, which are biased towards the axial centre of the cane attachment 89. In use, as illustrated in FIG. 13, the bottom tip of a cane (the part that contacts the ground) is inserted into the space 96 formed by the four rubber claws 94, engaging the rubber claws 94 so that the cane attachment 89 is securely attached to the bottom of the cane. A corresponding magnet 98 is placed in one (as seen in FIG. 6) or both(as seen in FIG. 7) of connectors 22 in bottom sole 18. The user uses the corresponding magnets to pick up the detached bottom sole 18 from the ground. The user can then simply pull the bottom sole off the cane attachment and store the bottom sole for future use.

Alternatively, magnets 90 may be built into the bottom of a cane. Alternatively, magnets 90 may be built into any stick or reaching device.

Optionally, an elastic port cover may be provided as part of the midsole, to protect the receiver ports from debris entering the port, which may interfere with a strong connection between the midsole and bottom sole. Turning to FIG. 14, an elastic port cover 100 covers receiver port 20. Turning to FIGS. 14-16, as connector 102 is inserted into receiver port 20 elastic port cover 100 stretches to allow connector 102 and receiver port 20 to make a strong connection. Turning to FIG. 17, upon detachment of the midsole 16 from bottom sole 18, or equivalently the detachment of connector 102 from receiver port 20, elastic port cover 100 returns to roughly its original position.

The elastic port cover may be made from any material that is sufficiently elastic and resilient, and thin enough to allow a good connection between connector 102 and receiver port 20. One example of a suitable material is ethylene vinyl acetate, or EVA.

An elastic port cover may be used with a wide variety of connection and release methods and mechanisms, including the approach illustrated in FIGS. 1-13. An elastic port cover may also be used with a release mechanism using magnets to detachably attach the bottom sole to the midsole, as described below.

In an alternative embodiment, the midsole 16 and bottom sole 18 are detachably attached using magnets. Turning to FIG. 14, there is provided a port magnet 104 and a complementary connector magnet 106. In use, the user simply steps onto bottom sole 18 with midsole 16 (midsole 16 having been previously attached to the user's shoe or boot). As seen in FIGS. 15 and 16, the connector magnet 106 is inserted into receiver port 20 and is attracted to port magnet 104. This attraction attaches bottom sole 18 to midsole 16.

FIGS. 14-17 show the system with an elastic port cover 100, and the attraction between port magnet 104 and a complementary connector magnet 106 must be strong enough to work through elastic port cover 100. Alternatively, in embodiments without an elastic port cover 100, port magnet 104 and a complementary connector magnet 106 attach directly.

Turning to FIG. 17, to detach the midsole 16 from midsole 18, the user presses release button 24 (for example, by knocking the heel of a boot or shoe against a wall). This moves slider 62 and moves port magnet 104 out of connection with connector magnet 106, resulting in bottom sole 18 detaching from midsole 16, as seen in FIG. 17.

There are a variety of patterns and numbers of receiving ports and connectors that could be used with the magnetic detachable attachment approach. In a preferred embodiment, there are at least two connector and complementary receiver ports on midsole 16 and bottom sole 18.

FIGS. 18 and 19 illustrate a preferred arrangement of receiver ports with magnets and release mechanism in the midsole. Turning to FIG. 18, there are provided five port magnets 104 arranged as seen in FIG. 18. FIG. 18 shows the five port magnets 104 in the rest or default position, as spring 64 biases the five port magnets 104 toward the heel. In this position port magnets 104 are located over receiver ports 20 (as seen in FIG. 14), and are available for attachment to corresponding connector magnets on a bottom sole. The connector magnets are arranged on the bottom sole in a complementary configuration. In use, the five port magnets 104 operate as seen in FIGS. 14-16 (with or without the optional elastic port cover 100).

To detach a bottom sole 18, the user presses release button 24 (for example, by knocking the heel of a boot or shoe against a chair leg). This moves slider 62 towards the front (or “toes”) of midsole 16, which in turn moves the five port magnets 104 towards the front (or “toes”) of midsole 16. This moves the port magnets 104 out of alignment with receiver ports 20 (as seen in FIG. 17), thus detaching the bottom sole 16 from midsole 18.

FIGS. 18-19 show one preferred embodiment with five port magnets in a particularly advantageous arrangement based on the distribution of connectors. This arrangement allows a stronger connection in areas of the sole that are most likely to involuntarily detach while the user is in a normal walking stride. Research and testing has shown that the heel and ball of the foot undergo the most stress and impact while walking, necessitating further securement specifically in those areas. However, there are many alternative arrangements of positioning and number of port magnets that would also work.

Any magnets that have an appropriate strength of attraction will work. In a particular embodiment, the individual magnets have a pull force of between 4 LB to 30 LB.

In a particular embodiment, the magnets are neodymium or rare earth magnets and are utilized for this mechanism due their mechanical properties, which create a strong magnetic connection in a small size. Grade N40-N52 may be utilized, where N52 is the strongest grade currently available. The neodymium magnet thicknesses could range between 1/16 of an inch to ⅛ of an inch, while the diameter could range between ¼ of an inch to ⅝ of an inch. The pull force of individual magnets could range between 4 LB to 30 LB.

In an alternative embodiment, programmed magnets or correlated magnets (also known as smart magnets), which are functional magnets that can be effectively programmed to have specific characteristics, are used. These magnets can be designed to, for example, release when turned, or attract only at specified distances. Numerous detachable attachment mechanisms can be designed that utilize the functionalities of programmed or correlated magnets. The pull force of the programmed or correlated magnets would generally range between 4 LB to 30 LB.

In one specific embodiment, programmed or correlated magnets that incorporate engagement gap functionality are used for the port magnets and connector magnets, which allows the magnets to only attract the corresponding magnet at a distance of ¼ of an inch or less.

In another specific embodiment, programmed or correlated magnets that incorporate special positioning functionality are used for the port magnets and connector magnets, which allows a small movement (around ⅛-⅜ inch) in the shear plane between two magnets to disengage the magnetic attraction. (This is in comparison to a standard neodymium magnet that needs to be fully out of contact with the other magnet in the shear plane in order to remove magnetic attraction.)

Through the appropriate selection of magnets, a cane attachment as seen in FIGS. 11-13 may be used to pick up a bottom sole that is equipped with a magnet system for detachable attachment to the midsole.

Although the forgoing description and accompanying drawings relate to specific preferred embodiments of the present invention as presently contemplated by the inventor, it will be understood that the invention is intended to be applied widely within the scope of the inventive concept as defined in the specification as a whole including the appended claims.

What is claimed is:

1. An apparatus, comprising:
a midsole and a bottom sole;
said midsole having a main component, at least one front body, a piece of material connecting the main component and at least one front body, and means for attaching the midsole to an ordinary boot or shoe;
the main component having a bottom surface and at least two receiver ports on the bottom surface, and a release mechanism with a release button;
said bottom sole having an upper surface and a lower surface, a grip enhancement device on its bottom surface and at least two connectors on its upper surface;
where said at least two connectors are adapted to attach by mating with the at least two receiver ports, and once attached the at least two connectors may be detached from the at least two receiver ports by engaging the release button.

2. The apparatus of claim 1, where the release mechanism is a slider with pins that intrude into the receiver ports and is biased by a spring.

3. The apparatus of claim 2, where the piece of material is elastic.

4. The apparatus of claim 3, where the piece of material is between 3-5 mm in thickness with a tensile strength of 2-3 MPa.

5. The apparatus of claim 1 where the main component is between ⅜″ to ½″ thick and made with a material with a Shore A number of around 40.

6. The apparatus of claim 1, further comprising a cane with a first magnet and a second magnet in one of the at least two connectors, the first and second magnets being oriented to attract.

7. The apparatus of claim 1, further comprising a cane attachment with a first magnet and a second magnet in at least one of the at least two connectors, the first and second magnets being oriented to attract.

8. The apparatus of claim 1, further comprising an elastic port cover covering at least one receiver port.

9. The apparatus of claim 1, where the at least two connectors are adapted to attach by mating with the at least two receiver ports using port magnets and connector magnets, and once attached the at least two connectors may be detached from the at least two receiver ports by engaging the release button.

10. The apparatus of claim 1, where the at least two connectors include a first magnet and the release mechanism includes a second magnet, where the first and second magnets are aligned to allow for detachable attachment of the midsole and bottom sole.

11. The apparatus of claim 10, where the release mechanism includes a spring and the second magnet intrudes into a receiver port when biased by the spring.

12. The apparatus of claim 11, where the second magnet slides out of the receiver port when the release button is engaged.

13. The apparatus of claim 12, where the second and first magnets are programmable magnets.

14. A kit comprising:
a midsole having a main component, at least one front body, a piece of material connecting the main component and at least one front body, and means for attaching the midsole to an ordinary boot or shoe, where the main component has a bottom surface and at least two receiver ports on the bottom surface, and a release mechanism with a release button;
a bottom sole having an upper surface and a lower surface, a grip enhancement device on its bottom surface and at least two connectors on its upper surface where at least one connector has a first magnet;
where said at least two connectors are adapted to attach by mating with the at least two receiver ports, and once attached the at least two connectors may be detached from the at least two receiver ports by engaging the release button.
and
a cane attachment with a second magnet, the first and second magnets being oriented to attract.

15. The kit of claim 14, where the release mechanism is a slider with pins that intrude into the receiver ports and is biased by a spring.

16. The kit of claim 14, where the release mechanism includes a third magnet, where the first and third magnets are aligned to allow for detachable attachment of the midsole and bottom sole.

17. The kit of claim 16, where the release mechanism includes a spring and the third magnet intrudes into a receiver port when biased by the spring and the third magnet slides out of the receiver port when the release button is engaged.

18. A method of use of the apparatus of claim 1, comprising the steps of:
attaching a midsole to a regular shoe or boot;
wearing the shoe or boot;
placing the bottom sole on the ground with the connectors facing upwards;
attaching the bottom sole to the midsole by stepping on the bottom sole with the midsole.

19. The method of use of claim 18, further comprising the steps of:
releasing the bottom sole from the top sole by engaging the release button.

20. A method of use of the kit of claim 14, comprising the steps of:
attaching a midsole to a regular shoe or boot;
wearing the shoe or boot;
placing the bottom sole on the ground with the connectors facing upwards;
attaching the bottom sole to the midsole by stepping on the bottom sole with the midsole;
releasing the bottom sole from the top sole by engaging the release button; and
using the attraction between the second magnet and the first magnet to pick the bottom sole off the ground.
